(19) United States
(12) Patent Application Publication
(10) Pub. No.: US 2015/0166127 A1
(43) Pub. Date: Jun. 18, 2015

(54) BUS HAVING IMPROVED BODY STRUCTURE FOR REDUCING AIR RESISTANCE WHILE CONSIDERING PASSENGERS

(71) Applicant: Chul Ho Kim, Seoul (KR)

(72) Inventor: Chul Ho Kim, Seoul (KR)

(73) Assignee: SEOUL NATIONAL UNIVERSITY OF TECHNOLOGY CENTER FOR INDUSTRY COLLABORATION, Seoul (KR)

(21) Appl. No.: 14/406,368

(22) PCT Filed: Jun. 11, 2013
(86) PCT No.: PCT/KR2013/005153

§ 371 Date: Dec. 8, 2014

(30) Foreign Application Priority Data
Jun. 11, 2012 (KR) 10-2012-0062276

(51) Int. Cl. B62D 35/00; B62D 31/02

(52) U.S. Cl. CPC B62D 35/00; B62D 31/02

(57) ABSTRACT

Provided is a bus including a door adjacent to a driver's seat. The bus includes a first front surface part and a second front surface part. The first front surface part is connected to a front end of the bus undersurface part, and is designed into a streamlined shape so as to reduce a pressure resistance by a still air pressure acting on a front surface of the bus during a running. The second front surface part assists a reduction of the pressure resistance and extends from an upper part of the first front surface part while being bent toward an inside of the bus so as to provide a boarding space for passengers through the door.

### CROSS-REFERENCE TO RELATED APPLICATIONS

This U.S. non-provisional patent application claims priority under 35 U.S.C. §119 of Korean Patent Application No. 10-2012-0062276, filed on Jun. 11, 2012, the entire contents of winch are hereby incorporated by reference.

### BACKGROUND OF THE INVENTION

The present invention disclosed herein relates to a bus having an improved body structure for reducing an air resistance while considering passengers, and more particularly, to a bus having an improved body structure for reducing an air resistance while considering passengers, which can reduce a pressure resistance occurring at the front side of a vehicle upon running of the bus and allow passengers to easily get on and off the bus by adopting both aerodynamic design and ergonomic design.

Vehicles undergo various types of air resistances during a high-speed running, and these air resistances largely occur throughout the front surface and the rear surface of vehicles. Particularly, when a vehicle has a large vertical area on the front surface of the vehicle, the form drag or pressure resistance on the front surface of the vehicle increases.

Thus, for typical commercial vehicles such as large-sized buses which can transport many passengers at once, endeavors to minimize the air resistance are being made, e.g., by forming edge portions of a vehicle body into a curved surface. However, since the buses have a substantially cuboidal shape on the whole, the buses undergo much air resistance during a high-speed running.

More specifically, as shown in FIG. 1, in case of typical large-sized buses having an overall appearance of a substantially cuboidal shape, the air flow stagnates at the front side of vehicles. Also, it can be verified that a vortex of the air flow occurs at the rear side of vehicles. These stagnation and vortex of the air flow at the front and rear sides of a vehicle are shown as a form (pressure) resistance at the front side of the vehicle and an inductive resistance at the rear side of the vehicle, respectively. Thus, the large-sized buses need larger transportation energy for high speed running due to the foregoing resistances.

For example, upon high-speed running at a speed of about 80 km/h or more, a vehicle undergoes an air resistance. In this case, the amount of fuel consumed increases in order to overcome the air resistance and maintain the high-speed running of about 80 km/h or more. Also, the high-speed running increases the atmospheric emission of harmful gases such as carbon dioxide (CO₂) or particle matter (PM), and thus incurs economic loss according to the amount of fuel consumed and environmental contamination.

Accordingly, in order to overcome the foregoing limitations in a related art, most commercial buses, as shown in FIG. 2, are designed in order to reduce the shape (pressure) resistance on the front side thereof such that the front shapes of the commercial buses are advantageous in terms of the air resistance.

More specifically, the windshields of commercial buses are designed so as to incline at an angle 1 of about 75 degrees to about 90 degrees to reduce the form resistance or the pressure resistance by the still air pressure on the front surface of vehicles. Also, commercial buses are designed to have a spoiler 2 on an upper edge of the rear side of the vehicles in order to reduce an inductive resistance by a vortex at the rear side of the vehicles.

However, the windshield inclining at an angle 1 of about 75 degrees to about 90 degrees at the front side of a vehicle has an insignificant effect on reducing the form resistance or the pressure resistance on the front surface of the vehicle.

In addition, technologies are being developed to reduce various types of air resistances applied to commercial vehicles such as largo-sized buses.

For example, Korean Patent Application Publication No. 10-2009-0058858 (published on Jun. 10, 2009) discloses “anti-air resistance system for large-sized car”.

This invention relates to a technology for improving the fuel efficiency by forming a flow against a flow field by an air resistance and thus minimizing the air resistance. However, this technology is configured to include additional components such as a compressed air tank storing compressed air to form a flow against a flow field by an air resistance, at least one nozzle connected to the compressed air tank and installed at a front side of a vehicle body to allow compressed air of the compressed air tank to be sprayed to the front side of the vehicle body, and a valve for spraying compressed air of the compressed air tank to be selectively sprayed through the nozzle.

Such additional components raise the manufacturing cost of a vehicle, and cause a complicated structure compared to other typical an reduction apparatuses. Also, the additional components incur additional costs according to the repair and replacement of parts after the inspection.

Accordingly, the development of a bus having an improved body structure which can expect the improvement of the air resistance reduction rate compared to typical air resistance technologies and can expect an improved economic effect by omitting the additional components is needed.

Also, the development of a bus having an improved body structure which can reduce the air resistance and contribute to solution of energy problem and reduction of harmful exhaust gases by saving transportation energy that is a worldwide issue and significantly reducing the emission of carbon dioxide (CO₂) that is recognized as a greenhouse gas among the harmful gases is needed.

### PRIOR ART DOCUMENT

### Patent Document

(Patent Document 1) Korean Patent Application Publication No. 10-2011-0023223 (published on Mar. 8, 2011)
(Patent Document 2) Korean Utility Model Application Publication No. 20-1998-047439 (published on Sep. 25, 1998)
(Patent Document 3) Japanese Patent Application Publication No. 2009-137558 (published on Jun. 25, 2009)

### SUMMARY OF THE INVENTION

The present invention provides a bus having an improved body structure for an air resistance reduction and a passenger, which can reduce the amount of fuel consumed and emission of carbon dioxide that is a greenhouse gas among harmful gases by reducing the air resistance generated at the front side of a vehicle through a double streamlined design of the front surface of a vehicle, can provide a sufficient getting-on/off space for passengers, and can transport the largest number of persons similarly to a typical commercial bus.

Embodiments of the present invention provide buses including a door adjacent to a driver's seat, the bus including: a first front surface part connected to a front end of the bus undersurface part and designed into a streamlined shape so as to reduce a pressure resistance by a still air pressure acting on a front surface of the bus during a running; and a second front surface part assisting a reduction of the pressure resistance and extending from an upper part of the first front surface part while being bent toward an inside of the bus so as to provide a boarding space for passengers through the door.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a view illustrating an air flow around a vehicle such as a bus and air resistances acting on the vehicle during a running of the vehicle;

FIG. 2 is a schematic view illustrating an installation angle of a front windshield of a typical bus;

FIG. 3 is a schematic view illustrating a first front surface part and a second front surface part of a vehicle such as a bus according to an embodiment of the present invention;

FIG. 4 is a view illustrating a rear surface, a side surface, and a top surface of a vehicle such as a bus according to an embodiment of the present invention;

FIG. 5 is a schematic view illustrating a motion of passenger in a bus according to an embodiment of the present invention;

FIG. 6 is a schematic view illustrating an inductive resistance reducing member of a bus with an improved front structure according to an embodiment of the present invention;

FIG. 7 is a view illustrating a typical commercial bus and a bus according to an embodiment of the present invention;

FIGS. 8 and 9 are graphs illustrating an air resistance and a drag coefficient applied to a vehicle when the buses of FIG. 7 run at a speed of about 120 km/h;

FIGS. 10 through 13 are views illustrating an air flow, a pressure distribution, and a turbulent energy distribution which are criteria in determining the magnitudes and causes of resistances generated when the respective bus models of FIG. 7 run at a speed of about 80 km/h to about 100 km/h;

FIGS. 14 through 17 are graphs illustrating power reduction, fuel reduction, economic effect, and reduction of carbon dioxide of a vehicle such as a bus according to an embodiment of the present invention;

FIG. 18 is a plan view illustrating a curved shape of a front side of a vehicle such as a bus according to an embodiment of the present invention;

FIG. 19 is a plan view illustrating curved shapes of front sides of respective vehicle models such as buses;

FIG. 20 is a schematic view illustrating a vehicle model M-50%;

FIG. 21 is a graph illustrating a change of a resistance coefficient in accordance with a change of the plane shape of a bus;

FIGS. 22 through 24 are views illustrating a change of the pressure distribution, a turbulent kinetic energy distribution, and an air flow speed distribution which are applied to vehicles such as buses of FIG. 19 when running at a speed of about 60 km/h;

FIG. 25 is a photograph illustrating a miniature vehicle such as a bus according to an embodiment of the present invention;

FIGS. 26 and 27 are photographs illustrating a vehicle such as the bus of FIG. 25 suspended on an electronic scale for a wind tunnel test;

FIG. 28 is a graph illustrating a change of the drag coefficient according to the yaw angle of wind, obtained from the wind tunnel test; and

FIG. 29 is a graph illustrating a comparison result of simulation and model experiments.

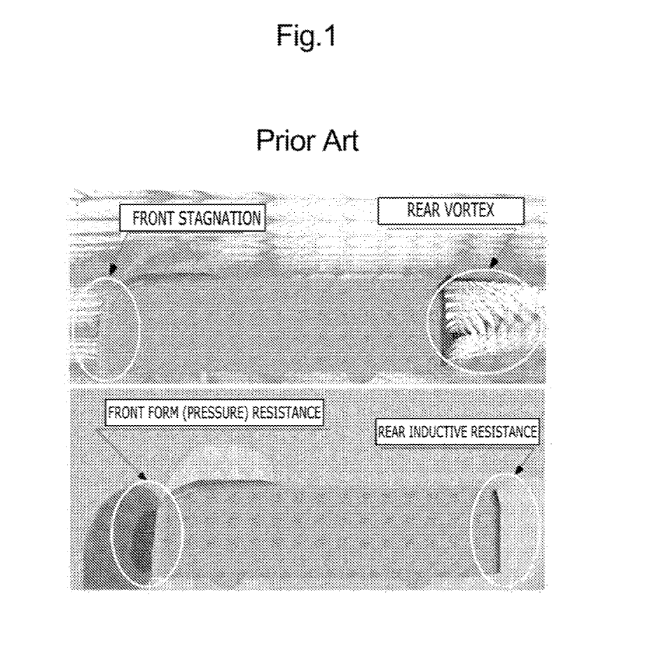

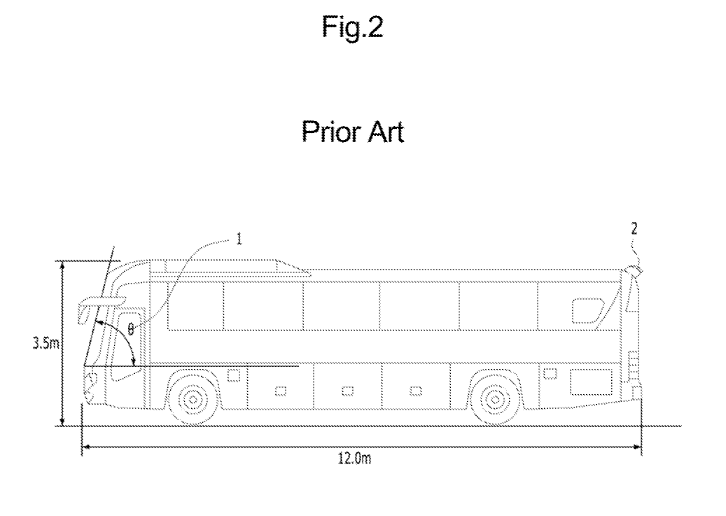

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

Hereinafter, a bus having an improved body structure for the air resistance reduction and passengers (hereinafter, referred to as a ‘bus with an improved front structure) according to an exemplary embodiment of the present invention will be described in detail with reference to the accompanying drawings.

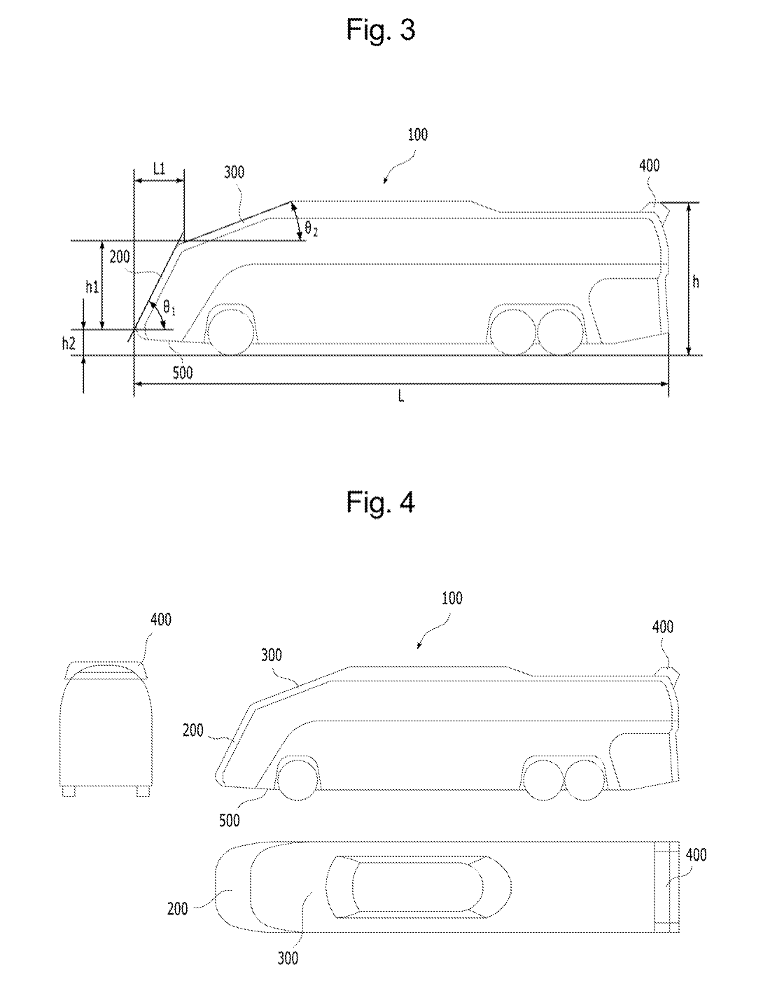

FIG. 3 is a schematic view illustrating a first front surface part and a second front surface part of a bus with an improved front structure according to an embodiment of the present invention. FIG. 4 is a view illustrating a rear surface, a side surface, and a top surface of a bus with an improved front structure according to an embodiment of the present invention

Referring to FIGS. 3 and 4, a bus with an improved front structure according to an embodiment of the present invention relates to a bus including a front surface part to which an aerodynamic design reducing a pressure resistance the front end of a vehicle and inducing an air flow over a vehicle into a laminar flow and an ergonomic design securing the visual angle of a driver and resolving inconvenience upon getting-on/off through a door near a driver's seat are both applied. Such front surface part may include a first front surface part 200 and a second front surface part 300.

Hereinafter, respective components will be described, in detail with reference to the accompanying drawings.

Referring again to FIGS. 3 and 4, the bus with the improved front structure according to the embodiment of the present invention may include the first front surface part 200.

The first front surface part 200 may be disposed at the front side to reduce the pressure resistance applied to the front surface during the running of a bus 100. The first front surface part 200 may be connected to the front end of a bus undersurface part 500, and may be designed into a streamlined shape at the front side of the bus 100.

More specifically, the first surface part 200 may be designed to have a streamlined shape at the front side of the bus 100. The front end of the first front surface part 200 connected to the front end of the bus undersurface part 500 may have a height h2 from the ground. The height h₂ with respect to the total height h of the bus 100 may be configured to range from about 0.12 to about 0.22. Here, h denotes the total height of the bus 100 from the ground, including the tire of the bus 100, and h₂ denotes the height from the undersurface of the tire to the front end of the first front surface part 200.

Also, the first front surface part 200 may be inclined such that the internal angle with respect to the x-axis corresponding to the ground ranges from about 43 degrees to about 63 degrees, preferably, may be inclined at an angle of about 59 degrees.

Here, when the internal angle Θ of the first front surface part 200 with respect to the x-axis exceeds about 63 degrees, the reduction effect of the pressure resistance applied to the front surface of the bus 100 may be reduced.

Also, when the internal angle Θ of the first front surface part 200 with respect to the x-axis is smaller about 43 degrees, the front side of the bus 100 may have an excessively sharp shape, and the total length of the bus 100 may increase compared to a typical commercial bus. Also, the height of the door (e.g., door located at the right side of the driver's seat) adjacent to the driver's seat may be lowered, and the height of the space in which the driver's seat is installed may be lowered, making it difficult for an adult to move while standing straight.

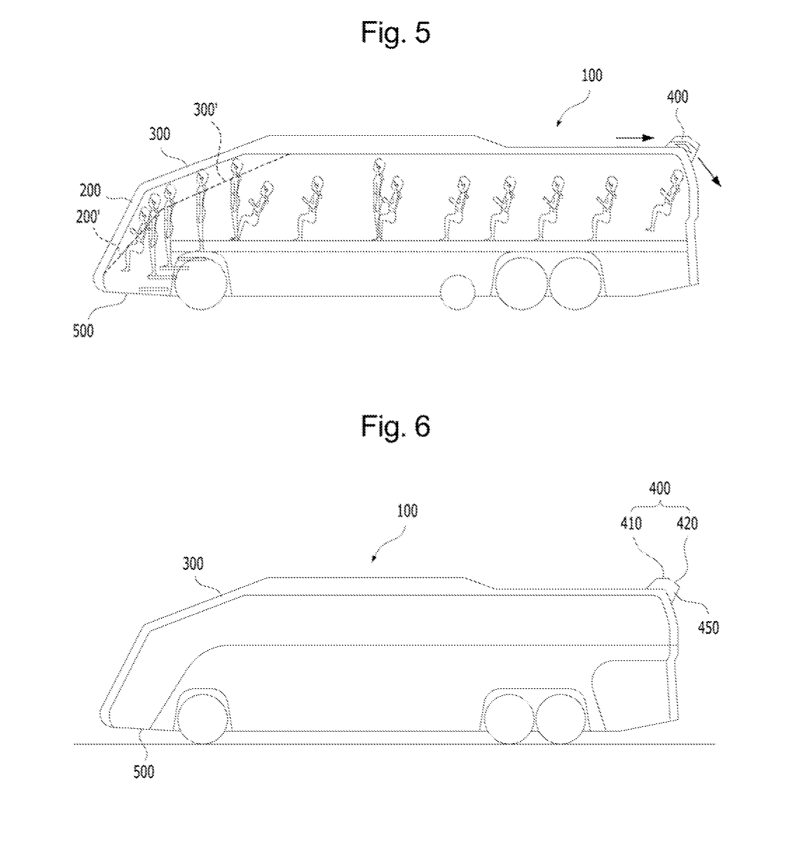

In other words, the bus 100 according to the embodiment of the present invention, as shown in FIG. 5, may provide a sufficient space for a passenger to get on or off while standing straight. However, as shown in FIG. 5, when the inclination surface of the first front surface part 200′ may be lowered to reduce the air resistance, a passenger may not get off a bus while standing straight.

Furthermore, a connection portion of the first front surface part 200 with the front end of the bus undersurface part 500 may have a circular arc shape. In this case, the connection portion may be formed to have a circular arc shape, the curvature of radius of which ranges about 1,400 mm to about 1,650 mm.

Referring again to FIGS. 3 and 4, the bus 100 with the improved front structure according to the embodiment of the present invention may include the second front surface part 300.

The second front surface part 300 may be installed at the front side of the bus 100 together with the first front surface part 200 in order to assist the reduction of the pressure resistance. In addition, the second front surface part 300 may serve to provide a sufficient boarding space such that a passenger does not feel inconvenience when getting on or off the bus 100.

For this, the second front surface part 300 may be designed to have a streamlined shape at the front side of the bus 100, and may extend so as to be bent toward the inside of the bus 100 from the upper part of the first front surface part 200.

More specifically, the second front surface part 300 may be configured such that a value L₁/L about the front end of the second front surface part 300 connected to the first front surface part 200 ranges from about 0.094 to about 0.136 and a value h₁/h ranges from about 0.62 to about 0.74.

Here, L denotes the total length of the bus 100, and L₁ denotes a length occupied by the first front surface part 200 among the total length of the bus 100. Also, h₁ denotes a height from the front end of the first front surface part 200 to the rear end of the first front surface part 200.

Also, the second front surface part 300 may be inclined such that the internal angle Θ₂ with respect to the x-axis corresponding to the ground ranges from about 17 degrees to about 37 degrees, preferably, may be inclined at an angle of about 21 degrees.

Here, when the internal angle ⊖2 of the second front surface part 300 with respect to the x-axis exceeds about 37 degrees, the reduction effect of the pressure resistance applied to the front surface of the bus 100 may be reduced. Also, when the internal angle ⊖2 of the second front surface part 300 with respect to the x-axis is smaller about 17 degrees, the height of the front side of the bus 100 may be lowered, and the size of the door of the bus 100 may be reduced, causing inconvenience in that a passenger needs to bent his/her body while passing the door.

The second from surface part 300 may be disposed over the first, and may be connected to the first front surface part 200 so as to have a circular arc shape. Furthermore, a connection portion of the first front surface part 200 and the second front surface part 300 may be formed to have a circular arc shape, the curvature of radius of which ranges about 1,400 mm to about 1,650 mm.

The streamlined design numerical values of the first front surface part 200 and the second front surface part 300 and the circular arc numerical values of the first front surface 200 and the second front surface part 300 were shown as valid fir least air resistance applied to the bus 100 during the running of the bus 100, based on the test result from “PHOENICS (ver. 2008)” which is a computational fluid dynamics analysis program from CHAM Inc. in United Kingdom and the result of a wind tunnel test of a model bus (1:10 scale). The wind tunnel tests using such miniature models were performed to determine the reliability about the simulation result. In general, in the aerodynamic design for vehicles, the first step research (simulation and model wind tunnel test) result shows the reliability of about 90% or more.

The bus with the improved front structure according to the embodiment of the present invention may further include an inductive resistance reducing member 400 and a support member 450.

FIG. 6 is a schematic view illustrating an inductive resistance reducing member of a bus with an improved front structure according to an embodiment of the present invention.

Referring to FIG. 6, the inductive resistance reducing member 400 may be disposed to reduce the inductive resistance generated by a vortex applied to the rear surface of a vehicle during the running of the vehicle. The inductive resistance reducing member 400 may be installed at a place spaced from an upper edge of the rear side of the bus 100, and may include a first wing 410 and a second wing 420.

The inductive resistance reducing member 400 may have as width corresponding to the width of the bus 100, but the present invention is not limited thereto.

The first wing 410 may be horizontally disposed in the longitudinal direction of the bus 100 while being spaced from the upper end of the bus 100. More specifically, the first wing 410 may be spaced from the upper end of the bus 100 by about 2% to about 6% of the length of the bus 100.

Also, the second wing 420 may extend from the first wing 410 to the rear surface of the bus 100, and may be formed to be downwardly bent. More specifically, the second wing 420 may have a length as long as about 4% to about 10% of the total length of the bus 100.

Furthermore, the second wing 420 may be bent and extended from the first wing 410 to the rear surface of the bus 100, and may be designed such that the bending degree thereof ranges from about 3 degrees to about 15 degrees.

On the other hand, the support member 450 may be disposed between the upper edge of the rear side of the bus 100 and the inductive resistance reducing member 400 such that the inductive resistance reducing member 400 can be spaced from the upper end of the bus 100.

Referring to FIG. 6, the support member 450 may be configured to have a pair of flat plates, and the pair of flat plates may be connected to a left side and a right side of the inductive resistance reducing member 400, respectively. However, the support member 450 may also be disposed between the bus 100 and the inductive resistance reducing member 400 while varying in numbers.

Various vehicles which are designed to have different shapes from a bus with an improved front structure according to an embodiment of the present invention will be described as below.

The tests on different vehicles are focused on whether or not improved effects are shown in terms of the air resistance and the drag coefficient and whether or not improved effects are shown in terms of power reduction, fuel saving, economic effect, and carbon dioxide reduction due to the improved effects of the air resistance and the drag coefficient.

FIG, 7 is a schematic view illustrating the exteriors of different buses used in the tests.

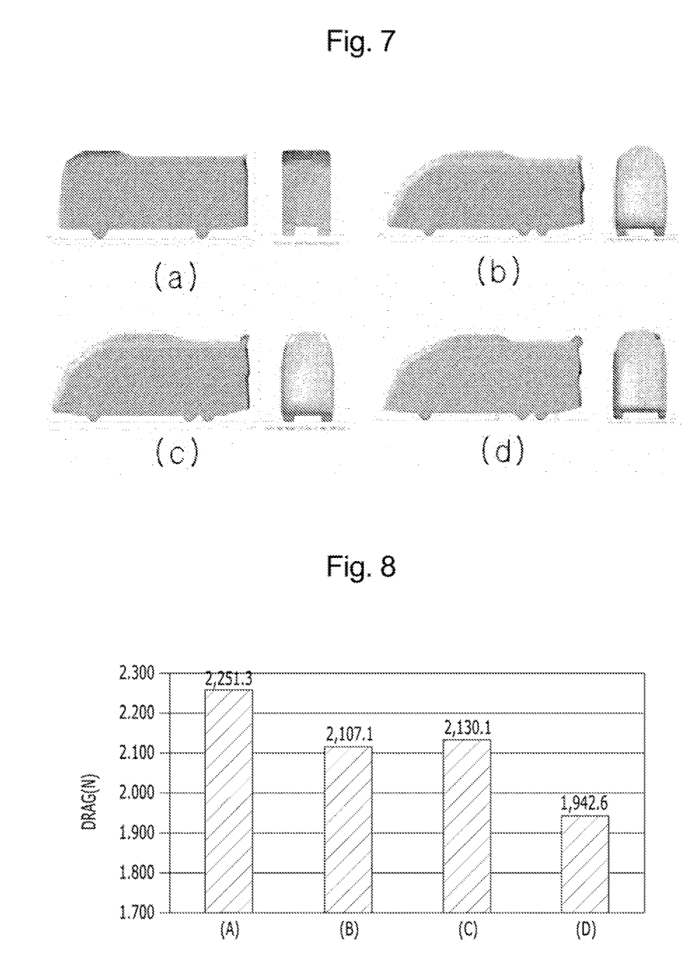

Referring to FIG. 7, (a) represents a typical bus model, and (b) to (d) represent bus models according to exemplary embodiments of the present invention. However, (b) is designed to have a clogged shape such that the inductive resistance reducing device does not pass air in a horizontal direction. (c) is designed to have a shape such that the inductive resistance reducing device at the rear side of a bus passes air in a horizontal direction. (d) is designed to have a shape such that the inductive resistance reducing device passes air in a horizontal direction and an inclined outlet angle inclines, emitting air in accordance with an inclined outlet angle.

The air resistances and the drag coefficients applied to vehicles during the running of the respective model commercial vehicles are as follows.

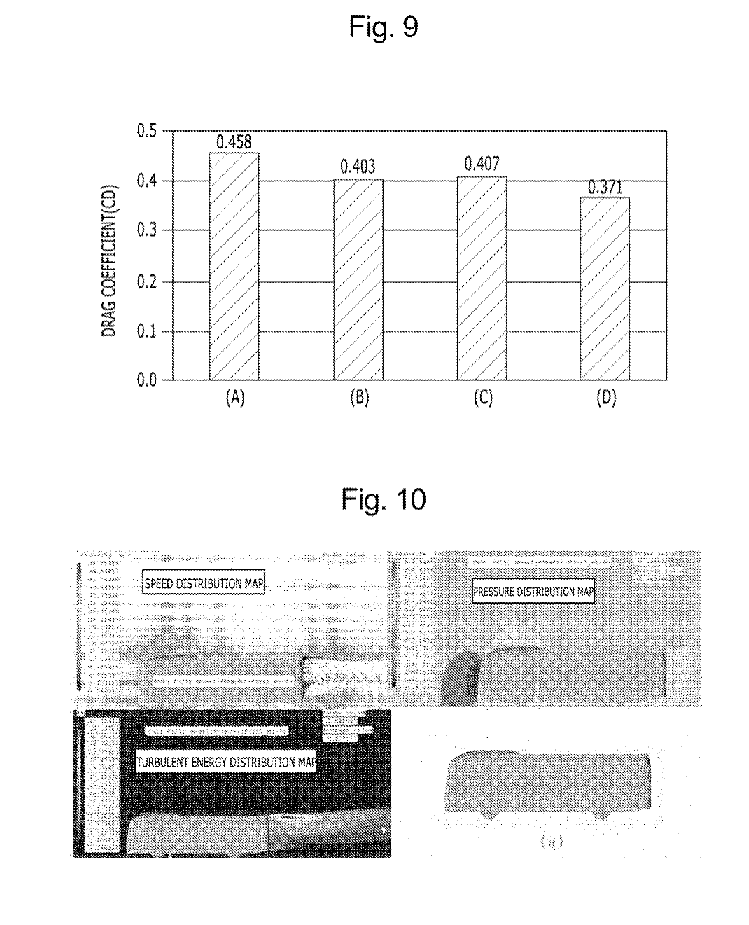

FIGS. 8 and 9 are graphs illustrating an air resistance and a drag coefficient applied to a bus when the model buses (a) to (d) run at a speed of about 120 km/h.

Referring to FIGS. 8 and 9, the air resistance and the drag coefficient may be reduced in the order of (a), (b), and (c). Also, it can be verified that the numerical values of (b) and (c) are similar to each other.

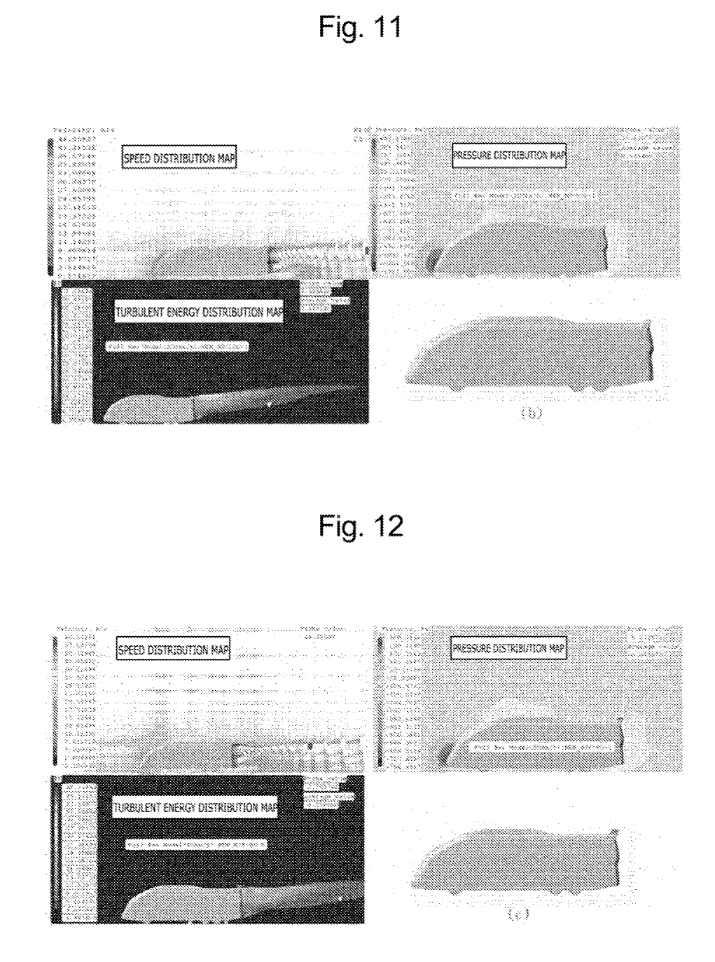

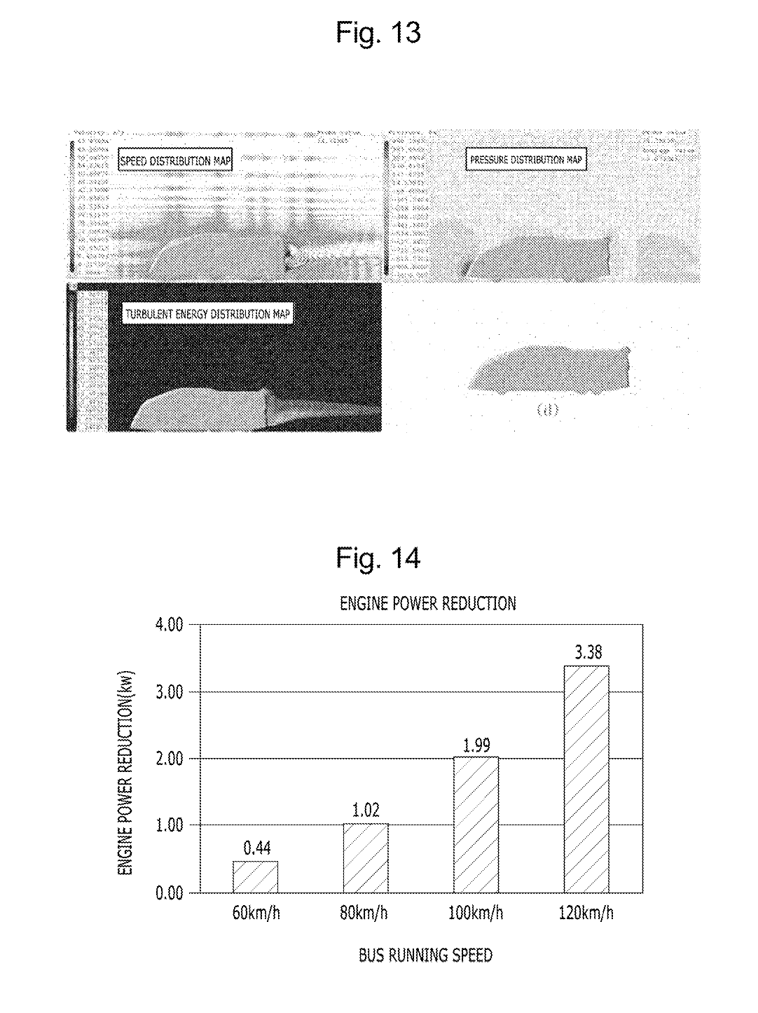

FIGS. 10 through 13 are views illustrating a magnitude of resistance and an air flow, a pressure distribution, and a turbulent energy distribution by models.

Referring to FIGS. 10 to 13, it can be verified that in the case (a) where the front side of a vehicle is not designed as a streamlined shape, since the air flow, the pressure distribution, and the turbulent energy distribution which are criteria in determining the magnitude and cause of resistance are highest, the air resistance according to the running is highest.

On the other hand, it can be verified that in the cases (b) to (d) where the front structures according to the present invention are applied, the an resistances become smaller compared to the case (a).

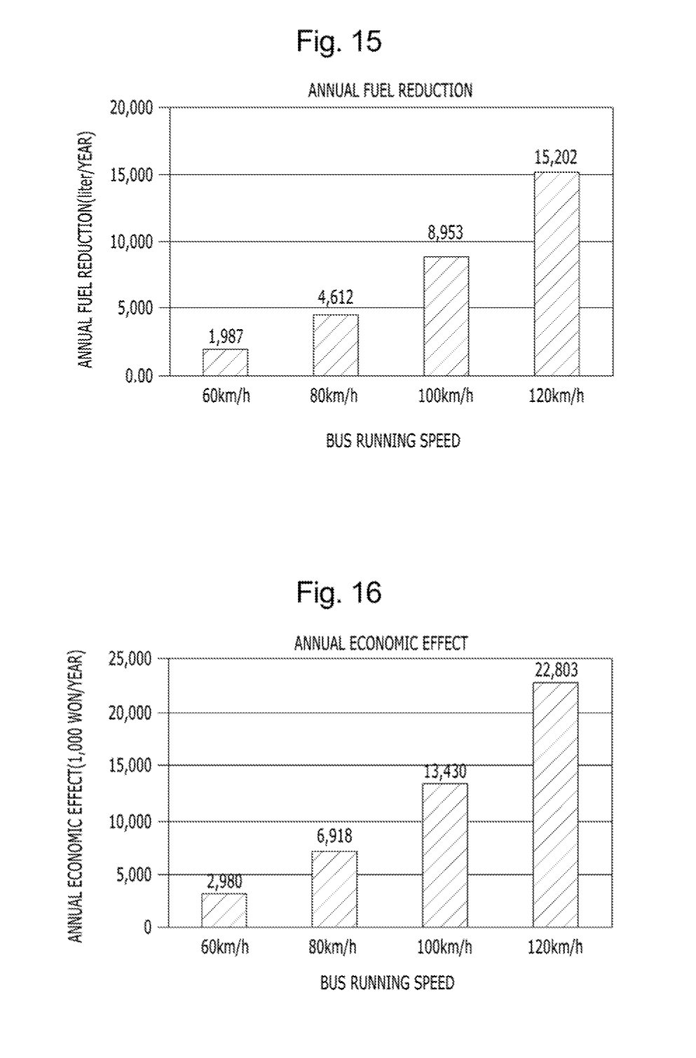

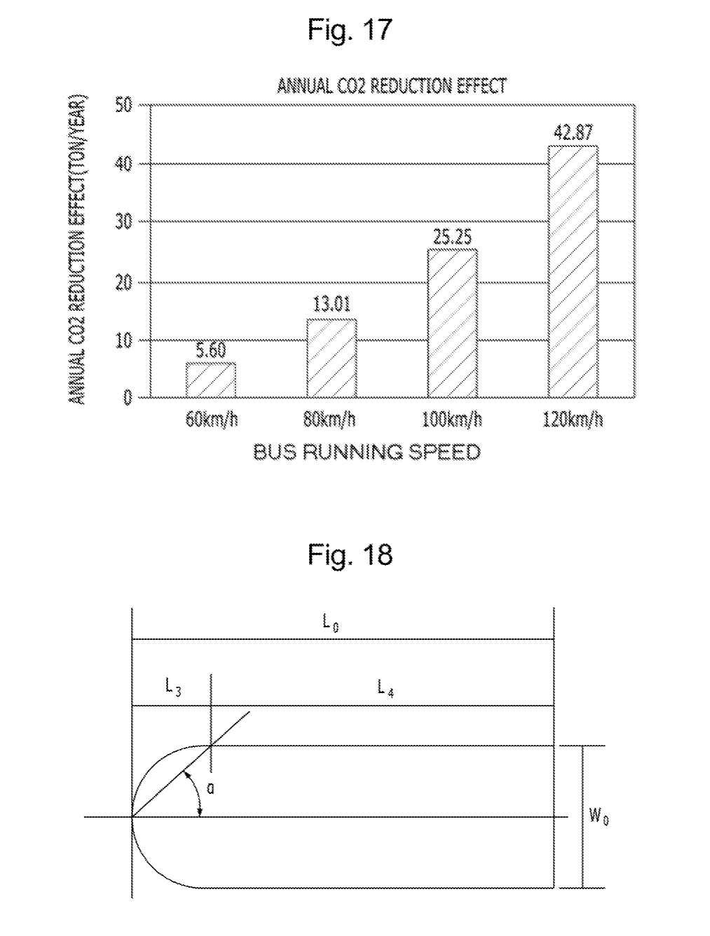

FIGS. 14 through 17 are graphs illustrating power reduction, fuel reduction, economic effect, and reduction of carbon dioxide of bus models (a) and (d).

Referring to FIGS. 14 to 17, the engine power reduction (d−a) between the model (a) and the model (d) was about 0.44 kW at a speed of about 60 km/h. Also, the engine power reduction (d—a) between the model (a) and the model (d) was about 3.38 kW at a speed of about 120 km/h

Similarly, a can be verified that in the case of the bus with the improved front structure according to the embodiment of the present invention, when the running speed increases from about 60 km/h to about 120 km/h, the power reduction, the fuel reduction, the economic effect, and the carbon dioxide reduction increase.

FIG. 18 is a plan view illustrating a curved shape of a front side of a bus such as a bus according to an embodiment of the present invention.

Referring to FIG. 18, a length L₃ from the front end of a bus to a point where the curvature of the front surface part ends based on the total length L₀ of the bus in order to reduce the pressure resistance acting on the bus may be configured as follows:

0.01L₀≦L₃≦0.1L₀

Here, the front surface part may include the first front surface part 200 and the second from surface part.

In this case, when L₃ is smaller than 0.01 L₀, the front shape of the bus may become similar to the shape of a typical bus, and the drag coefficient (C_{D}) may reach the value (more than about 0.45) of a typical bus. Accordingly, the air resistance reduction effect may be reduced. Here, C_{D} is a dimensionless coefficient irrelevant to the speed, and denotes a property value affected by the Shape of a vehicle, which is called the coefficient of drag.

Also, when the L₃ exceeds 0.01 L₀, the front shape of the vehicle may become excessively sharp. In other words, in order to secure the boarding space similar to that of a typical bus, the length of the bus may become excessively longer or the number of passengers' seats may be reduced. Accordingly, the operation economic efficiency may be lowered, and the entry and exit of passengers through the front door may become difficult.

Also, based on the total width W0 of the bus as shown in FIG. 18, the angle α defined by the front end of the front surface part of the bus and the portion where the curvature of the front surface part ends up may be expressed as follows:

$${Tan}^{- 1} ( \frac{{W}_{o}}{0.02 {L}_{o}} ) \leq a \leq {Tan}^{- 1} ( \frac{{W}_{o}}{0.25 {L}_{o}} )$$

Here, the front surface part may include the first front surface part 200 and the second front surface part 300.

In other words, the angle α denotes an angle formed by the line from the front center point of the vehicle to the point where the curvature of the first front surface part 200 and the second front surface part 300 ends up with respect to the center line of the vehicle.

In this case, when the angle α is smaller than

$${Tan}^{- 1} ( \frac{{W}_{o}}{0.02 {L}_{o}} ) ,$$

the front shape of the bus may become similar to that of a typical bus, the value C_{D} may reach a value (more than about 0.45) of a typical bus, thereby reducing the reduction effect of the air resistance.

Also, when the angle exceeds

$${Tan}^{- 1} ( \frac{{W}_{o}}{0.25 {L}_{o}} ) ,$$

the front shape of the vehicle may become excessively sharp. In other words, in order to secure the boarding space similar to that of a typical bus, the length of the bus may become excessively longer or the number of passengers' seats may be reduced. Accordingly, the operation economic efficiency may be lowered, and the entry and exit of passengers through the front door may become difficult.

In order to observe the effect according to the curvature of the front shape of the bus, different kinds of buses which are designed into different curvatures are compared as follows.

In this case, the tests on the different curvature shapes are focused on whether or not improved effects are shown in terms of the drag coefficient and whether or not improved effects are shown in terms of the size of resistance by models, the air flow, the pressure distribution, and the turbulent energy distribution.

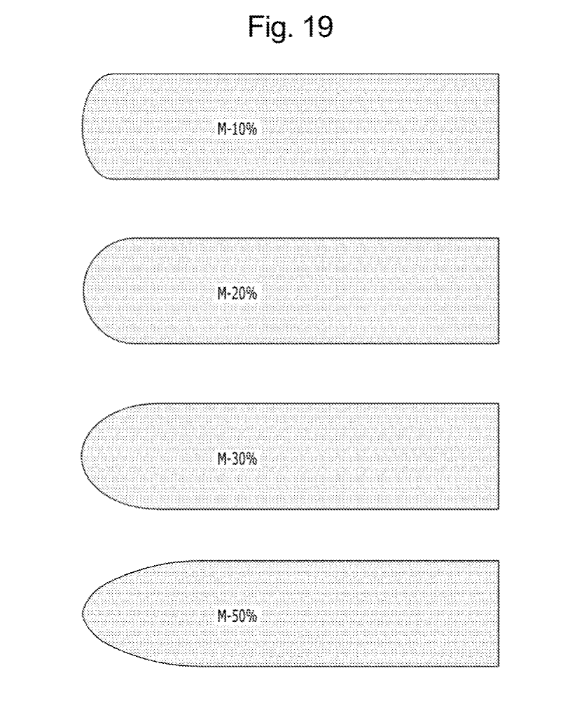

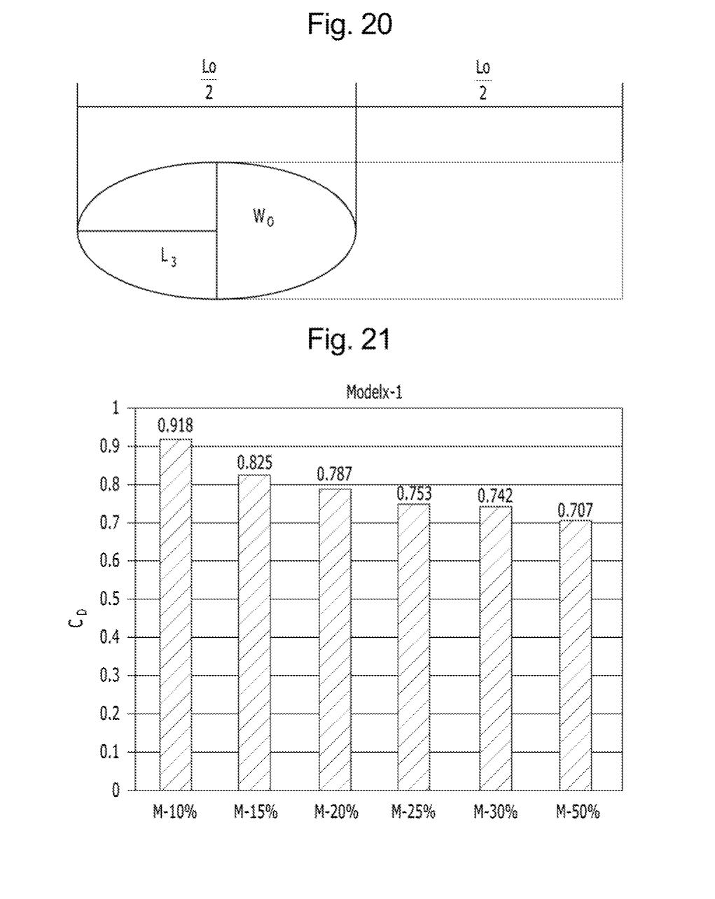

FIG. 19 is a plan view illustrating curved shapes of front sides of respective vehicle models such as buses. FIG. 20 is a schematic view illustrating a vehicle model M-50%. FIG. 21 is a graph illustrating a change of a resistance coefficient in accordance with a change of the plane shape of a vehicle such as a bus.

As shown in FIG. 19, models M-10%, M-20%, M-30%, and M-50% were used in the test. Here, the front shapes of buses are expressed as elliptical equations. The meaning of M-50% is that the length of L₃ of an ellipse (when the short length is W₀) corresponds to about 50% of the half (L₀/2) of the total length of the vehicle as shown in FIG. 19. In other words, the model M-10% means that the length L₃ corresponds to 10% of the half (L₀/2) of the total length of the vehicle.

Referring to FIG. 21, it can be verified that the drag coefficient is lowered in the order of model M-10%, model M-20%, model M-25%, model M-30%, and model M-50%.

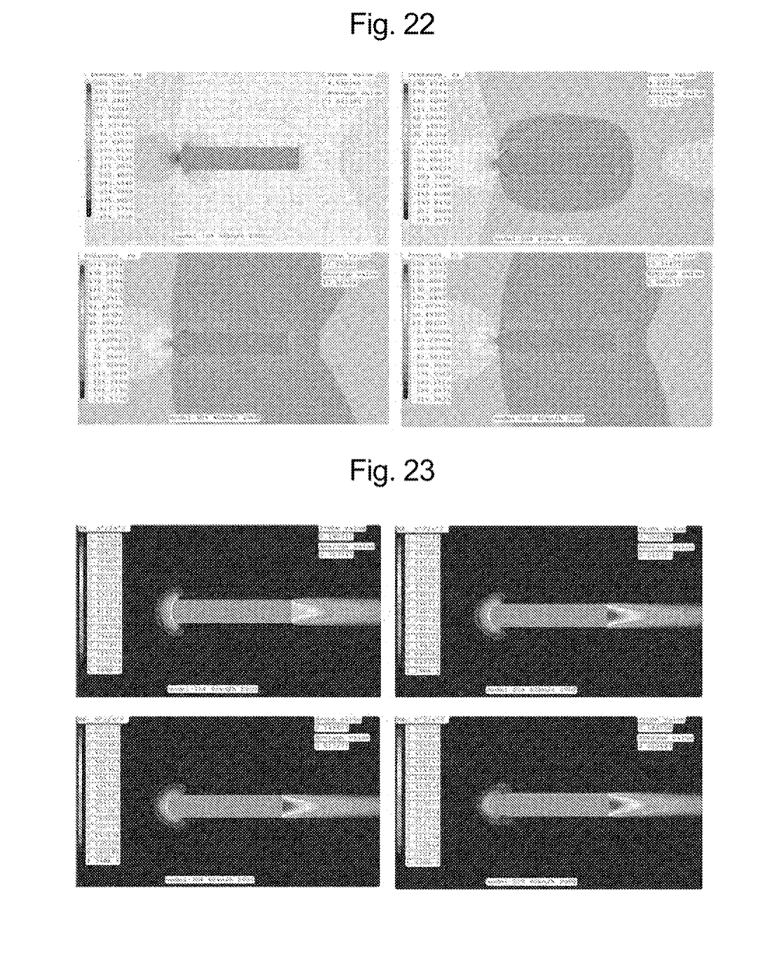

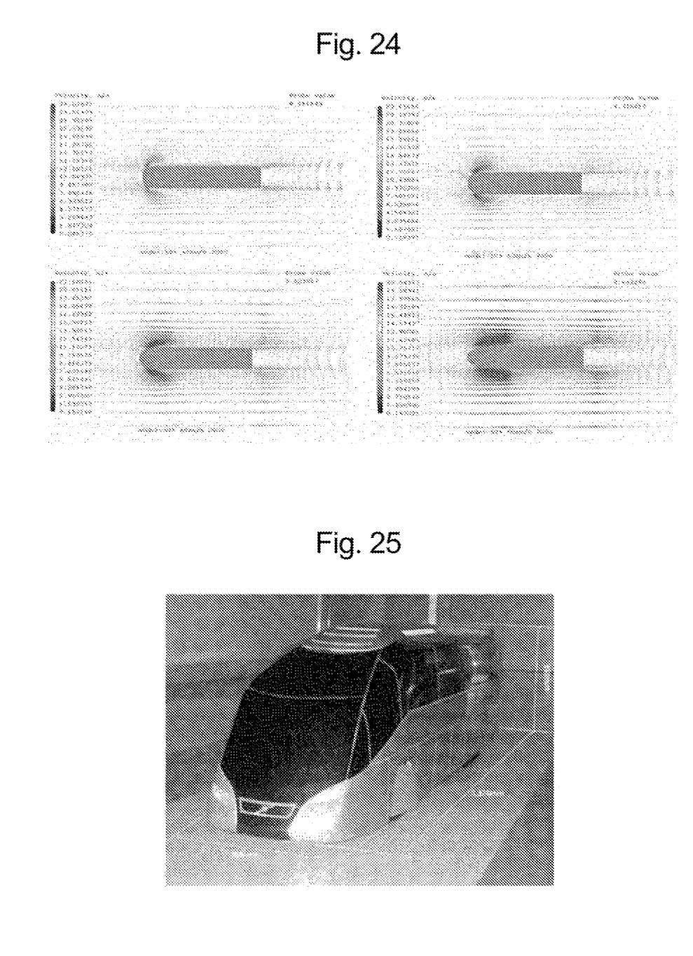

FIGS. 22 through 24 are views illustrating a change of the pressure distribution, a turbulent kinetic energy distribution, and an air flow speed distribution which are applied to vehicles such as buses of FIG. 19 when running at a speed of about 60 km/h

Referring to FIGS. 22 through 24, it can be verified that when the front shapes of the vehicle including the first front surface part 200 and the second front surface part 300 are sharper, the air flow, the pressure distribution, and the turbulent energy distribution become smaller.

Thus, it can be verified that when the front end of the buse is sharper, the air resistance becomes smaller. However, when L₃ deviates from 0.01 L₀≦L₃≦0.1 L₀, and the angle α deviates from

$${Tan}^{- 1} ( \frac{{W}_{o}}{0.02 {L}_{o}} ) \leq a \leq {Tan}^{- 1} ( \frac{{W}_{o}}{0.25 {L}_{o}} ) ,$$

the air resistance may become similar to that of a typical vehicle or limitations may occur in the manufacturing of vehicles and the operation enconomic efficiency.

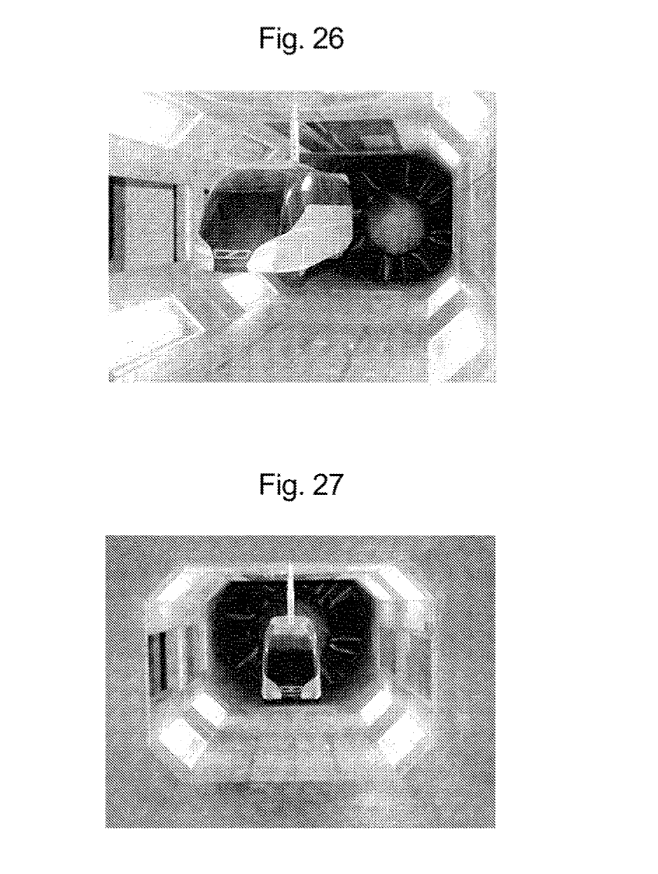

FIG. 25 is a photograph illustrating a 1/10-scaled miniature vehicle such as a bus according to an embodiment of the present invention. FIGS. 26 and 27 are photographs illustrating a vehicle such as the bus of FIG. 25 suspended on an electronic scale for a wind tunnel test.

As shown in FIGS. 25 to 27, an aerodynamic test of a miniature vehicle was performed using a wind tunnel. In this wind tunnel test, the vehicle was geometrically miniaturized in x, y, and z directions. All angles of the vehicle were not changed.

More specifically, the aerodynamic test used a miniature model in which the bus (L₃: 1.32 m) according to the embodiment of the present invention is scaled by 1/10. The speed of the vehicle for the test was changed from about 60 km/h to about 120 km/h. Also, the test was performed using a closed-type subsonic wind tunnel of the aeronautical engineering department of the University of Sydney. In this case, the length of the bus was scaled into 1:10, and the angles ⊖₁⊖₂, α were not changed.

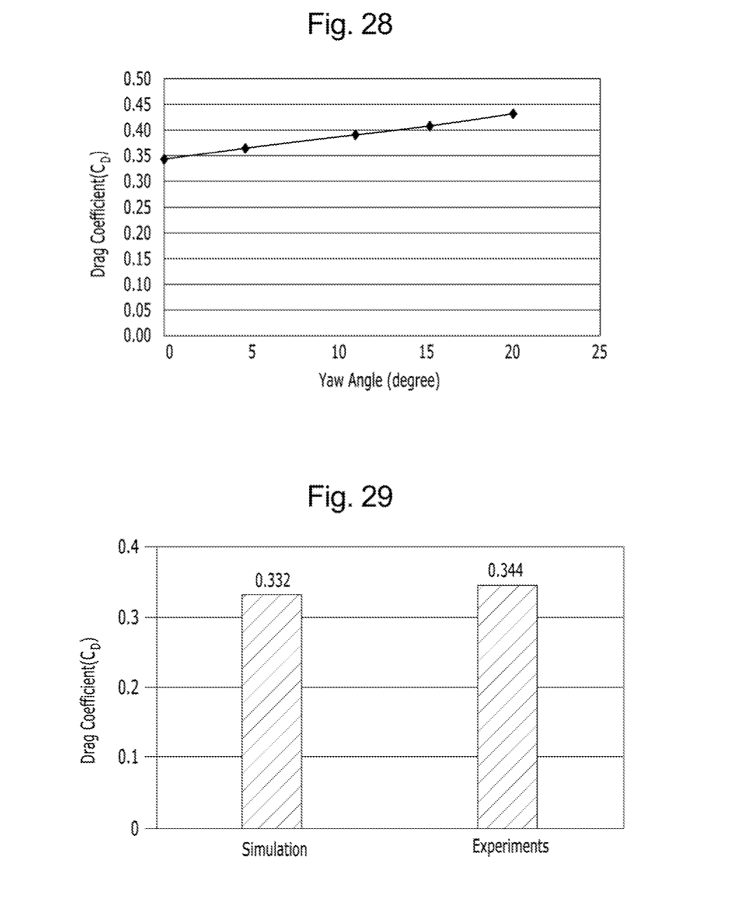

In the result of the wind tunnel test, as shown in FIG. 28, it can be seen that C_{D} is 0.344 when the angle of wind is 0 degree. This can verify that the air resistance is reduced by 24.9% compared to 0.458 of a typical vehicle such as a bus. Also, it can be verified that the air resistance of a bus model (which is not limited in curvature of the front shape) according to this embodiment of the present invention is reduced by about 7.3% compared to 0.371. Thus, the value C_{D} of the vehicle varies with models regardless of the change of the speed. Accordingly, the values C_{D} shown in FIG. 28 are mean values of the values C_{D} measured while changing the speed of the vehicle.

FIG. 29 is a graph illustrating a comparison result of simulation and model experiments.

Referring, to FIG. 29, the values C_{D} applied to the bus were 0.344 in the wind tunnel test using the miniature model and 0.332 in the simulation, respectively. As a result, the simulation result using the computational fluids engineering technology and the aerodynamic test result of the miniature model using the wind tunnel showed an error of about 3.6%. Accordingly, the error range of the two test results is smaller than about 4%, and it can be verified that the air resistance acting on the bus according to the embodiment of the present invention was reduced compared to the air resistance acting on a typical bus.

As described above, the present invention adopts the front surface structure similar to the patent application entitled “bus having improved structure for reduction of air resistance” and filed on Aug. 31, 2009 by the present applicant. However, the present invention relates to a development of a bus having optimal air resistance and maximum number of passengers by applying the study results about an effect of the curved shape of a vehicle on the drag coefficient (C_{D}) of the vehicle in the plan view of the vehicle.

In other words, the present invention does not simply adopt the first front surface part 200 and the second front surface part 300 which differ in slope, but defines optimal length, height and slope of the first front surface part 200 and the second front surface part 300 through various studies. Furthermore, the present invention relates to a development of a bus having minimized air resistance while securing a boarding space equal or similar to a typical bus, by considering the curved shapes of the first front surface part 200 and the second front surface part 300 from the plan view of the vehicle.

When the front end of a vehicle is configured to have a sharp shape, the air resistance acting on the vehicle can be more reduced than the present invention.

However, when a bus is produced while adopting a sharp shape and maintaining the size of a typical bus, the boarding space of the bus may be reduced by about 30% or more compared to that of a typical bus. Also, in order to secure the boarding space equal to that of a typical bus while adopting a sharp shape, a bus needs to have a longer length than the typical bus, and the weight thereof increases compared to the typical bus.

As a result, when a bus having a sharp front structure is manufactured in the same size as a typical bus, the air resistance may be reduced and the fuel may be saved compared to a typical bus, but the transportation number of passengers may be reduced. Also, when a bus having a sharp front structure in order to secure the same transportation number of passengers as a typical bus is manufactured to have a longer length than the typical bus, inconvenience may occur in the running of the bus due to a long length of the bus, and fuel consumption may increased due to increased weight thereof.

In these aspects, the present has an effect of reducing the air resistance compared to a typical bus while securing a sufficient boarding space for passenger and having a size similar to that of a typical bus.

When applied to vehicles such as buses, the present invention can significantly reduce the air resistance upon running, and thus can significantly reduce the transportation energy. For example, the fuel efficiency can be improved by about 15% to about 25% compared to a typical bus. According to the improvement of the fuel efficiency, carbon dioxide (CO₂) that is a greenhouse gas can be reduced by about 15 tons per year, thereby significantly improving the atmospheric environment.

Also, the present invention can provide a sufficient visual field for driver, can provide a sufficient space such that a passenger does not feel inconvenience when getting on or off through a door near the driver's seat, and can transport the largest number of persons similarly to a typical bus.

It may also correspond to a well-known technology to control the air resistance by adjusting the inclination angle of the front window of a typical bus. This is because the air resistance acting on the front window of a bus can be reduced when the inclination angle becomes smaller. However, when the inclination angle of the front window is configured to be small in order to reduce only the air resistance, the front surface of a bus has a sharp structure, and this bus may have three serious limitations. First, when the sharp structure is adopted, compared to a typical bus having the same largest number of passengers, the whole size of the bus may increase. Also, since the refraction of light occurs according to the inclination degree of the front structure of the bus, the visual field of a driver cannot be sufficiently secured, and it is difficult for a driver to recognize the distance. Finally, since the size of the door near the driver's seat of a bus becomes smaller, passengers may feel uncomfortable upon getting-on/off.

Accordingly, by combining the ergonomic technology and the aerodynamic technology, the present invention can reduce the air resistance while maintaining the whole size of a bus. Thus, the present invention has a differentiated effect from a typical technology for reducing only the resistance.

In addition, a bus according to an embodiment of the present invention can significantly reduce the an resistance, and can lower a vortex at the rear side of a bus, thereby enabling a high-speed running while maintaining the silence and running stability of a vehicle body.

The above-disclosed subject matter is to be considered illustrative and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. A bus comprising a door adjacent to a driver's seat, the bus comprising:
a first front surface part connected to a front end of the bus undersurface part and designed into a streamlined shape so as to reduce a pressure resistance by a still air pressure acting on a front surface of the bus during a running; and
a second front surface part assisting a reduction of the pressure resistance and extending from an upper part of the first front surface part while being bent toward an inside of the bus so as to provide a boarding space for passengers through the door.

2. The bus of claim 1, wherein a connection portion of the first front surface part and the front end of the bus undersurface part has a circular are shape.

3. The bus of claim 1, wherein a connection portion of the second front surface part and the first front surface part has a circular arc shape.

4. The bus of claim 2, wherein the connection portion is formed to have a circular arc shape, a radius of curvature of which ranges from about 1,400 mm to about 1,650 mm.

5. The bus of claim 1, wherein in the first front surface part, a height ratio (h₂/h) of a front end of the first front surface part connected to the front end of the bus undersurface part with respect to a total height of the bus from the ground ranges from about 0.12 to about 0.22, and an internal angle with respect to an x-axis corresponding to the ground ranges from about 43 degrees to about 63 degrees.

6. The bus of claim 1, wherein: in the second front surface part,
a length ratio (L₁/L) of a length from a front end of the first front surface part to a front end of the second from surface part with respect to a total length of the bus ranges front about 0.094 to about 0136;
a height ratio (h₁/h) of a height from the front end of the first front surface part to the front end of the second front surface part with respect to a total height of the bus from the ground ranges from about 0.62 to about 0.74; and
an internal angle with respect to an x-axis corresponding to the ground ranges from about 17 degrees to about 37 degrees.

7. The bus of claim 1, further comprising an inductive resistance reducing member disposed at an upper edge of a rear side of the bus so as to reduce an inductive resistance by a vortex.

8. A bus having a length (L₃) from a front end of the bus to a point where a curvature of a front surface part of the bus ends, based on the total length (L₀) of the bus, expressed as follows:
0.01L₀≦L₃≦0.1L₀.

9. The bus of claim 8, wherein an angle (α) between a central line of the bus based on a total width of the bus and a line from the front end of the bus to the point where the curvature of the front surface part of the bus ends, expressed as follows:
$${Tan}^{- 1} ( \frac{{W}_{o}}{0.02 {L}_{o}} ) \leq a \leq {Tan}^{- 1} ( \frac{{W}_{o}}{0.25 {L}_{o}} ) .$$

10. The bus of claim 8, wherein the front surface comprises:
a first front surface part connected to a front end of the bus undersurface part and designed into a streamlined shape so as to reduce a pressure resistance by a still air pressure acting on front surface of the bus during a running; and
a second front surface part assisting a reduction of the pressure resistance and extending from an upper part of the first front surface part while being bent toward an inside of the bus so as to provide a boarding space for passengers through the door.

11. A bus comprising a door adjacent to a driver's seat, the bus comprising:
a first front surface part connected to a front end of the bus undersurface part and designed into a streamlined shape so as to reduce a pressure resistance by a still air pressure acting on a front surface of the bus during a running; and
a second front surface part assisting a reduction of the pressure resistance and extending from an upper part of the first front surface part while being bent toward an inside of the bus so as to provide a boarding space for passengers through the door,
wherein:
in the first front surface part, a height ratio (h₂/h) of a front end of the first front surface part connected to the front end of the bus undersurface part with respect to a total height of the bus from the ground ranges from about 0.12 to about 0.22, and an internal angle with respect to an x-axis corresponding to the ground ranges from about 43 degrees to about 63 degrees;
in the second front surface part,
a length ratio (L₁/L) of a length from a front end of the first front surface part to a front end of the second front surface part with respect to a total length oaf the bus ranges from about 0.094 to about 0.136;
a height ratio (h₁/h) of a height from the front end of the first front surface part to the front end of the second front surface part with respect to a total height of the bus from the ground ranges from about 0.62 to about 0.74; and
an internal angle with respect to an x-axis corresponding to the ground ranges from about 17 degrees to about 37 degrees;
a length (L₃) from a front end of the bus to a point where a curvature of a front surface part of the bus ends based on the total length (L₀) of the bus, is expressed follows:
0.01L₀≦L₃≦0.1L₀; and
an angle (α) between a central line of the bus based on a total width of the bus and a line from the front end of the bus to the point where the curvature of the front surface part of the bus ends, is expressed as follows:
$${Tan}^{- 1} ( \frac{{W}_{o}}{0.02 {L}_{o}} ) \leq a \leq {Tan}^{- 1} ( \frac{{W}_{o}}{0.25 {L}_{o}} ) .$$

12. The bus of claim 3, wherein the connection portion is formed to have a circular arc shape, a radius of curvature of which ranges about 1,400 mm to about 1,650 mm.

13. The bus of claim 9, wherein the front surface part comprises:
a first front surface part connected to a front end of the bus undersurface part designed into a streamlined shape so as to reduce a pressure resistance by a still air pressure acting on a front surface of the bus during a running; and
a second from surface part assisting a reduction of the pressure resistance and extending from an upper part of the first front surface part while being bent toward an inside of the bus so as to provide a boarding space for passengers through the door.
